(19) United States
(12) Patent Application Publication
(10) Pub. No.: US 2007/0031797 A1
(43) Pub. Date: Feb. 8, 2007

(54) MATHEMATICAL SPORTS LEARNING CARDS, GAMES AND METHODS OF USE THEREOF

(76) Inventor: Andrew J. Mendelson, Sewell, NJ (US)

Correspondence Address: ANTOINETTE G. GIUGLIANO, P.C., 390 SALEM STREET, LYNNFIELD, MA, 01940, US

(21) Appl. No.: 11/161,537

(22) Filed: Aug. 8, 2005

(51) Int. Cl. G09B 19/02; G09B 23/02

(52) U.S. Cl. 434/188

(57) ABSTRACT

The present invention relates to a mathematical sports learning card that has a front face having a pictorial representation of one or more sports players, and a header to identify the type of math problem. The card also has a back face having sports statistics for use in the math problem, and one or more math problems utilizing the sports statistics. The present invention further includes an answer to the math problems. The answer to the math problem can be placed either on a separate answer card, or on the back face of the math problem card in lettering that is set apart from the question. The present invention also involves a math sports learning card system that includes a plurality of the math sports learning cards described above. Accordingly, the present invention pertains to methods of using the cards of the present invention, and methods of making the cards.

### BACKGROUND OF THE INVENTION

Mastering basic math skills, such as addition, subtraction, multiplication, division and averages, proves to be a difficult task for some children. In a study performed by the National Center for Education Statistics in 2003, math scores of fourth graders from United States significantly lag behind those from several other countries, including Singapore, Japan, Netherlands, and England. Children, from the U.S. and other countries, often struggle to understand various mathematical concepts because they are often viewed as too abstract or remote.

Hence, a need exists to develop new ways to interest or excite children about learning math. In one aspect, a need exists to convey mathematical concepts to children in a manner to which they can practically relate. In particular, a need exists for conveying mathematical concepts to children by utilizing their interest in sports.

### SUMMARY OF THE INVENTION

The present invention relates to a (e.g., one or more) mathematical learning sports learning card that has a first face (e.g., front face) having a pictorial representation of one or more sports players, and a header to identify a type of math problem (e.g., addition, subtraction, multiplication, division, averages, or combinations thereof). The cards of the present invention also have a second face (e.g., a back face) having sports statistics for use in the math problem, and one or more math problems or questions that utilize the sports statistics. The cards of the present invention further include an answer to the math problem, wherein the answer is placed either on a separate answer card, or on the back face in lettering that is set apart from the math problem or question. The pictorial representation of the one or more sports players includes players from any and all types of sports, e.g., baseball players, football players, soccer players, basketball players, hockey players, or Olympic players. The card has a length ranging between about 1½″ to about 8½″0 (e.g., about 3″ to about 4″), and a width ranging between about 1½″ to about 6½″ (e.g., about 1″ to about 3″). The sports statistics on the back face includes actual statistics from games played by the player or by the player's team. The math problems on the back include, in one embodiment, addition problems, subtraction problems, multiplication problems, division problems, problems to calculate averages, or combinations thereof. The front face can optionally include the player's name, position, team, or combination thereof. The back face can optionally include a formula or instruction set used to solve the math problems. The answer to the math problem, in an embodiment, is included on a separate answer card. The separate answer card has a front face having a pictorial representation of one or more sports players, and the header; and a back face having an answer to the one or more math problems. Preferably, the pictorial representation of the player and the header on the answer card match or correlate to that on the corresponding mathematical problem card. In another embodiment, the answer to the math problem is included on the back face of the card in lettering that is upside down or sideways. Another aspect of the present invention relates to mathematical sports learning card systems that have a plurality of math problem cards described herein. The present invention also encompasses mathematical sports learning card games that include a plurality of math problem cards described herein, and optionally include items traditionally included in a game (e.g., a spinner, one or more dice, a game board, or combination thereof).

The present invention embodies methods of using the mathematical sports learning card described herein. The methods encompass, in part, introducing the math problem to an individual. Introducing the math problem includes either the individual reading the math problem, or a second individual reading the math problem to a first individual. The methods further involve determining a possible answer by the individual, and then comparing the possible answer with the answer on the separate answer card or on the back face of the card. The answer can be compared by the individual, or the individual can communicate the answer to a second individual who then checks the answer for accuracy. Hence, the methods can be performed with one or more individuals.

Methods of making the mathematical sports learning cards described herein are also encompassed by the present invention. The methods include placing (e.g., adhering or printing) a pictorial representation of one or more sports players and a header to identify the type of math problem on a front face of the card. The methods also involve placing sports statistics for use in the math problem, and one or more math problems that require use of the sports statistics to solve the math problem on the back face of the card. Also encompassed by the method is the step of placing the answer to the math problem either on a separate answer card, or on the back face in lettering that is set apart from the question. Any combination of elements described herein can be placed on the card of the present invention.

The present invention has several advantages. The present invention provides a way for children to learn several aspects of math, including addition, subtraction, multiplication, averages, and division. The present invention does so in a way that interests children by applying real life sports-related statistical information to mathematical problems, in a format that many children love, namely on a sports card (e.g., a baseball or football card).

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a drawing showing the front face, including a header to signify the learned skill (e.g., batting averages), a pictorial image of a sports player, the player's name, position and team, for one embodiment of the mathematical sports learning card.

FIG. 1B is a drawing depicting the back face of an embodiment of the mathematical sports learning card that includes the card number, actual player statistics, batting average formula, and a series of math problems.

FIG. 1C is a drawing displaying the front face of a checklist answer card of an embodiment of the present invention that includes the learned skill (e.g., batting averages), a pictorial image of the sports player, and the player's name, position and team.

FIG. 1D is a drawing showing the back face of a checklist answer card in one embodiment of the present invention and includes the card number, the formula used to solve the problem, and the answers to the math problems.

FIG. 2A is a drawing showing the front face, including a header to signify the learned skill (e.g., addition and subtraction), a pictorial image of a sports player, the player's name, position and team, for one embodiment of the mathematical sports learning card.

FIG. 2B is a drawing depicting the back face of an embodiment of the mathematical sports learning card and includes the card number, actual player statistics, a series of math problems, and answers to the math problems written upside down.

FIG. 3A is a drawing showing the front face, including a header to signify the learned skill (e.g., addition), a pictorial image of a sports player, the player's name, position and team, for one embodiment of the mathematical sports learning card.

FIG. 3B is a drawing depicting the back face of an embodiment of the mathematical sports learning card and includes the card number, actual player statistics, a series of math problems, and answers to the math problems written sideways.

### DETAILED DESCRIPTION OF THE INVENTION

A description of preferred embodiments of the invention follows.

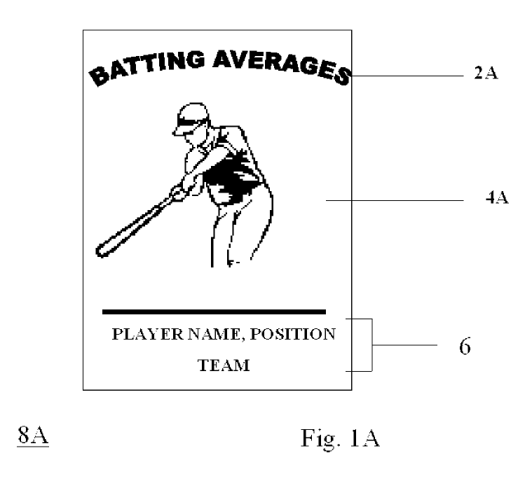

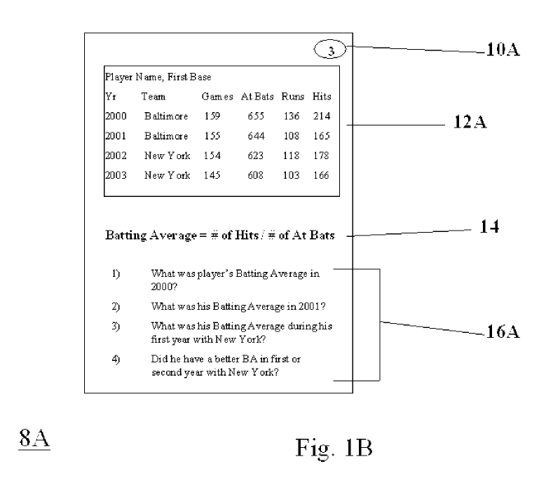

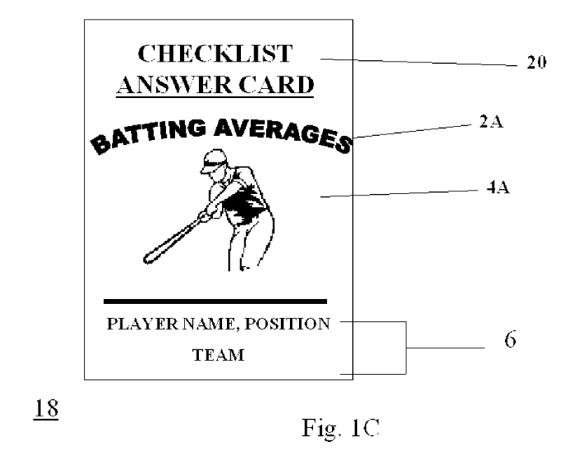

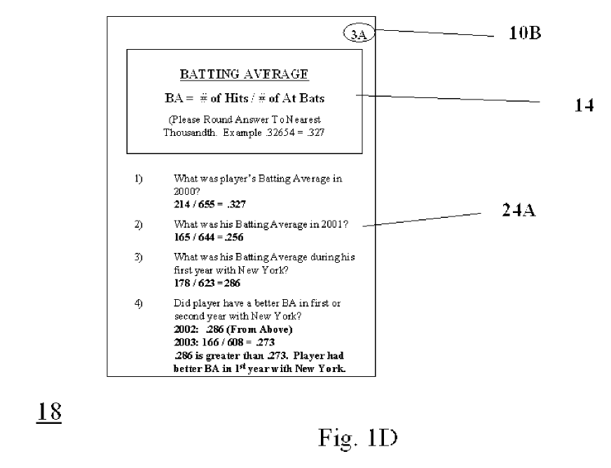

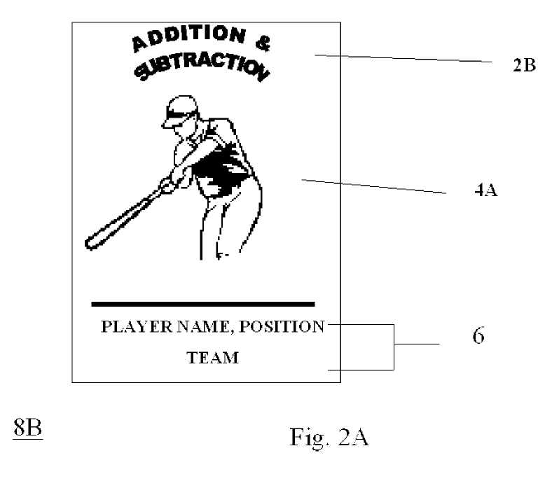

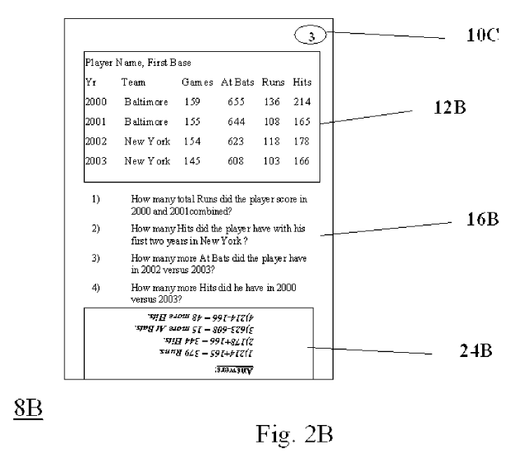

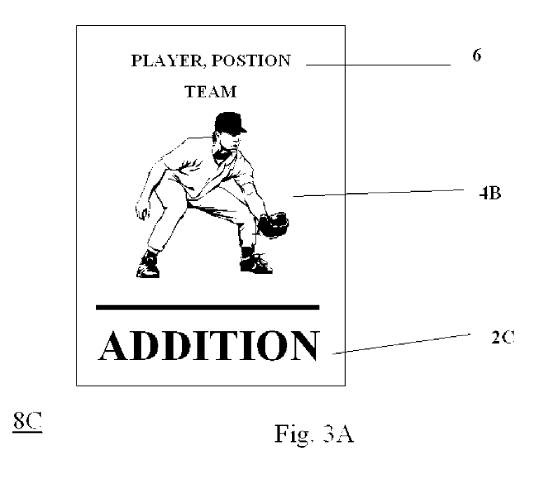

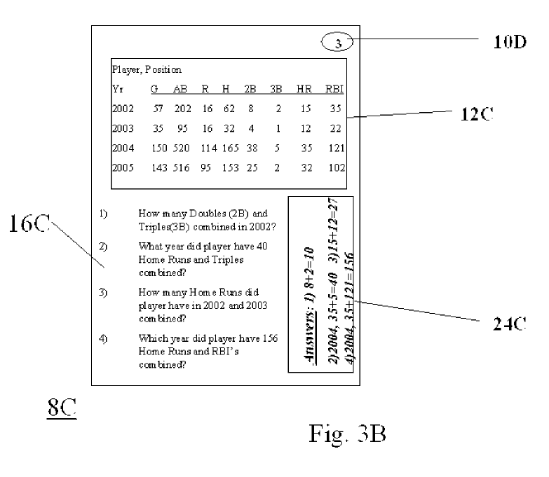

The present invention relates to mathematical sports learning cards and systems. The present invention is a learning tool that provides individuals with a fun way to learn mathematical skills. Referring to FIG. 1A, mathematical sports learning card 8A in one embodiment is shown, and has one or more elements including a header identifying the learned skill, a pictorial representation of one or more sports players, and a player identifier for indicating the player's name, position and team. The front face (e.g., first face) of learning card 8A has header 2A entitled “Batting Averages.” Headers, such as header 2A, are designed to signify the type of math problems that will be provided on the back face (e.g., second face). Any header designed to signify the type of math problems can be used, including written terms, phrases or symbols. Examples of written terms or phrases include Addition, Subtraction, Division, Multiplication, Averages, or combinations thereof. FIG. 2A has header 2B, “Addition & Subtraction” and is an example of a header using more than one math problem type. Symbols for use in the header can be any symbol that identifies the type of math problem(s) (e.g., +, −, ), X). The header can be combined with other terms that are related to the sport involved, for example, “Batting Average.” The header can appear anywhere on the front face of the card, in various fonts and lettering. In one example, FIGS. 1A and 2A have headers across the top, and FIG. 3A has a header, header 2C, across the bottom region. The location and/or style of lettering are not important so long as the type of math problem is identified, and the lettering is legible.

The embodiment of FIG. 1A also has pictorial representation 4A of a sports player. The sports learning cards of the present invention can have one or more sports players, e.g., a single player or the entire team. The pictorial representation can be a photograph, drawing, painting, or other representation that shows the likeness of the player(s). Preferably the pictorial representation is one of a famous player. The player can be from any number of sports. Examples include baseball, football, basketball, soccer, rugby, Olympics, or any type of sport now known or later developed. As with the header, the pictorial representation can be placed anywhere on the front face, and in any size so long as it fits on the card. The pictorial representation can be of a posed player (e.g., a posed shot) or of a player engaged in the sport (e.g., an action shot), as shown in pictorial representations 4A and 4B.

FIG. 1A also has player identifier 6. The player identifier provides the user with the player's name(s), position, team, date, or any combination thereof. As with the header and the pictorial representation, the player identifier can be anywhere on the front face of card 8A. In this case, the player identifier is at the bottom of card 8A, but it can be at the top, the middle or on the sides of the front face of the mathematical sports learning cards of the present invention. The lettering, color and background of the identifier can vary so long as the lettering is legible.

The sports learning card shown in FIG. 1A is the size of a trading card (e.g., preferably about 2½″ in width by about 3½″ in length). The size of the card of the present invention can range between about 1½″ to about 6½″ in width, and about 1½″ to about 8½″ in length. The mathematical sports learning cards can be made from any material that is suitable for marking the card with the elements of the present invention, as described herein (e.g., suitable for marking the card with the header, pictorial representation, player identifier, math problems, answers, and the like). For example, the card can be made from paper or plastic. The paper can be heavy weighted paper, such as a card stock (e.g., about 50 lbs. to about 130 lbs.). The paper can be coated with material to protect the card from becoming damaged, or prevent from the markings of the card elements from wearing off. Preferably, the card is made from a durable and quality card stock. The mathematical sports learning card and elements of the card can be in color, or black & white. The sports learning cards of the present invention can further include icons commonly related to the sport (e.g., bats or gloves for baseball, helmets or goal posts for football, and a soccer ball for soccer).

The back face of card 8A is shown in FIG. 1B. The back face of mathematical sports learning cards of the present invention has one or more of the following elements, including a card number, actual player statistics, math problems, and any mathematical formulas needed to solve the math problem. Card 8A has card number 1OA in the upper right-hand corner. The card number provides a card in a series with a number so that the user can more easily keep track of the cards. The card number can consist solely of the designated card number (e.g., 3), or can be used in combination with the total number of cards in the series (e.g., 3 of 20). As with all elements described herein, the card number can be placed anywhere on the face of the card, and any font style or background can be used, so long as it is legible.

The back face of card 8A also depicts sports statistics 12A to be used in math problems 16A. The back face of the mathematical sports learning card contains sports statistics that are preferably those actually derived from the player, the sport or combination thereof. Types of statistics are numerous and vary depending on the type of sport. For example, in baseball common statistics include number of games, number of times at bat, number of runs, and number of hits. In football, common statistics range from number of completed passes, number of yards run, number of fumbles, number of field goals, etc. Such statistics can be derived from the game or player itself, obtained from a sports news organization, or sports website (e.g., www.baseball-reference.com). The statistics used on the card of the present invention should be suitable for the type of math problem presented thereon. For example, card 8A has statistics 12A that describe the year, the team played, the number of games, number of times at bat, the number of runs and the number of hits. Such data is ideal to calculate batting averages, the basis for math problems 16A.

Card 8A also has formula 14 for calculating batting averages, shown in FIG. 1B, while card 8B and 8C of FIGS. 2B and 3B, respectively, do not have any formulas shown on the back face. Formulas can optionally appear on the cards, depending on the level of difficulty of the math problems. The mathematical sports learning cards of the present invention can have various levels of difficulty, or be designed for specific age groups. The difficulty level can be affected in any number of ways and, for example, by varying the types of numbers used (e.g., whole numbers or decimal numbers), the type of math problem presented (e.g., addition, as compared with multiplication), or by providing or not providing formulas needed to solve the problems. The formula can be presented in words, symbols or a combination thereof.

In addition to formulas, the math sports learning cards of the present invention can further include instructions for getting to the answer. The instructions can be placed on the problem card, the answer cards or both. Including instructions or tips for getting to the answer is optional, and can depend on the intended level of the user. See the Exemplification Section for examples.

The back face of card 8A of FIG. 1B includes one or more math problems. The math problems used for the present invention can vary in type and complexity. Any area of math now known, or later developed, can be used with the present invention. The type of math problems includes basic calculations such as addition, subtraction, multiplication, division, averages, whole numbers, decimals, percentages, and any other suitable area typically learned in school or college. Other than basic calculations, types of math problems can further include problems relating to calculus, geometry, trigonometry, and the like. For example, using geometry, the distance of a throw from first to third base can be calculated if the user was given the distance and angles between the bases. One or a series of math problems can be presented on a single card. The problems can be related to one type of math, or can exhibit a variety of math types (e.g., two can be related to addition, and two can be related to subtraction). In such a case, the header on the front of the card can indicate all types (e.g., addition and subtraction), or indicate that a variety or mixture of math types exists. In the case of a plurality of math questions, the questions are preferably numbered (e.g., 1, 2, 3 . . . ) or lettered (e.g., A, B, C . . . ) to provide an order to the questions. This order can be mirrored when providing the answers to the math problems.

FIG. 1C shows an embodiment for displaying the answers to the math problems. Answer card 18 is a separate card that mirrors math learning card 8A. For example, header 2A, pictorial image 4A and player identifier 6 are the same on both cards. The front face of answer card 18 has a different header than the card 8A. Answer card header 20 utilizes the label “Checklist Answer Card.” Checklist cards are often used in baseball cards to summarize the cards of the series. However, in this case the checklist answer card is used to provide answers to a corresponding card with math problems on it. The header for the answer card and other elements of the present invention can vary, and contain terms that relate to the player's sport. For example, for a football answer card can use headers such as “touchdown answer card” or “scoreboard answer card,” and a hockey answer card can use phrases such as “hat-trick answer card.” As shown in FIG. 1D, formula 14 is repeated for the convenience of the user. Any formula that is used to calculate the answers preferably appears on the answer card. Answer card 18 shows the answers that corresponding to the questions presented on Card 8A, in the same order with the same numbering. In an embodiment, consistent numbering or lettering of the questions and corresponding answers occurs (e.g., both the questions and corresponding answers are designated 1, 2, 3, . . . or A, B, C, . . . ). The questions can optionally be repeated on the answer card, as shown in FIG. 1D, for ease of use. In such a case, the math problems can be set apart from the answers by putting the problems and answers in different text types and/or coloring. The methodology of obtaining the answer is also present in certain aspects of the invention. The presence of the methodology of the calculations on the answer card allows the user to better understand how to solve this and similar problems.

Instead of appearing on a separate answer card, answers to the math problems can also appear on the same card, but set apart from the answers. Preferably, the answers are set apart in such a way so that they are not easy to ready when reading the question. For example, the answers can be in a smaller text at the bottom, upside down or sideways. FIGS. 2A and B show card 8B having questions pertaining to both addition and subtraction. Answers 24B to math problems 16B are set apart by being presented upside down and in smaller text than the text of the rest on the rest of Card 8B. In this case, answers 42B are numbered sequentially and match math problems 16B. 305 Similarly, FIGS. 3A and B show card 8C, a card for addition, as signified by header 2C. On the back face of card 8C, answers 24C to math problems 16C are offset by being printed sideways on the right side. The answers, in certain aspects, can be printed on any side or anywhere in the card so long as the answers are set apart from the math problems. The present invention optionally embodies providing a label for the answers. In another embodiment, the answers can be covered by a flap that hides the answers while the questions are being read and the problem is being analyzed.

Answer card 18A also includes card number 10B. Card number 10B, labeled “3A” corresponds to card number 10A (labeled “3”) on math problem card 8A. Card number 10B, in addition to the number, has a designation after it to indicate that it is an answer card, namely the letter “A” for answer. Other designations can be used, and include, for example symbols common to the sport.

The present invention further relates to a card system or card game having a plurality of the cards described herein. In particular, the card system or game of the present invention has one or more math problem cards described herein. The system of game of the present invention includes one or more math problem cards with and/or without answers directly on them, separate corresponding answer cards, or a combination thereof. A card system can have any number of cards ranging from about 2 to about 100. In one embodiment, a series of 10 math problem cards and 10 answer cards are combined to form a series of 20 cards. In another embodiment, 20 math problems cards of the present invention with answers on the back are included in a series.

In addition to a plurality of cards, the present invention can include items normally found in games such as spinners, boards, and/or dice. For examples, groups of individuals can be divided up into “teams” and the spinner and/or dice can be used to determine the order in which a person has a turn. During their turn, the person can attempt to answer one or more math problem/question. This is repeated for each person, and the team with the most correct answers wins the game. This is only an example of a game that could be played using the cards of the present invention. Any game that includes one or more of the math problem cards and/or answer cards described herein is encompassed by the invention.

Similarly, the present invention includes methods for using the cards described herein. The methods can be used by a single user, or multiple users. In either case, the math problem on a card of the present invention is introduced to an individual, meaning the question is either read by the user or read to the user by another. The user determines a possible answer and compares his/her possible answer with the answer provided either on the math problem card or on a separate answer card, as described herein. Alternatively, if more than one user is involved, the user can communicate the possible answer to a second user and the second user can compare the possible answer to the answer provided. In such a case, the users can take turns answering questions using the math problem cards of the present invention. Using an embodiment of the present invention that includes separate cards for problems and answers is ideal for multiple users, such as that shown in FIGS. 1A-D.

Methods of making a mathematical sports learning card described herein are also embodiments by the present invention. The methods include placing or attaching the elements described herein to a material (e.g., paper or plastic) suitable for use as a card. In particular, the methods include placing a pictorial representation of one or more sports players and a header to identify the type of math problem on a first face of the card. The methods also includes placing sports statistics for use in the math problem, and one or more math problems that require use of the sports statistics to solve the math problem on the second face of the card. Additionally, the methods involve placing the answer to the math problem either on a separate answer card, or on the second face in lettering that is set apart from the math problem or question. The cards of the present invention can contain additional elements and/or decoration, and can be protected by a coating or cover.

Exemplification

### EXAMPLE 1

### Batting Averages Math Problem Card and Separate Answer Card

The cards shown in FIGS. 1A-D are made by printing the elements shown in the figures on white, card stock (Hammermill wt. 110 lbs.) on a high quality laser printer, and cut to 2½″(width) by 3½″(length). “Batting Averages” is the header that is placed at the top of the front face, along with a famous baseball player's image, and the player's name, position and team at the bottom. The back face of the math problem card is printed with card number (i.e., 3), the actual player's statistics printed outlined in a text box, the batting average formula and 4 math questions. (Fig. 1B) The answer checklist is printed on the same paper as the math problem card, and cut to the same size. The front of the answer checklist card is identical to the math problem card, except for the header, which reads “Checklist Answer Card.” The back of the answer card has corresponding card number (i.e., 3A) and restates the batting average formula, with instructions for rounding the answer to the nearest thousandth. The math problem questions are repeated and numbered as shown on the math problem card, and the answers to the questions printed after it. A series of 10 math problem cards and 10 corresponding answer cards are made for a total of 20.

### EXAMPLE 2

### Addition and Subtraction Card With Answers Placed Upside Down

The card shown in FIGS. 2A-B is made by printing the elements shown in the figures on white, card stock (Hammermill wt. 110 lbs.) on a high quality laser printer, and cut to 2½″ (width) by 3½″ (length). “Addition & Subtraction” is the header that is placed at the top of the front face, along with a famous baseball player's image, and the player's name, position and team at the bottom. (FIG. 2A) The back face of the math problem card is printed with card number (i.e., 3), the actual player's statistics printed outlined in a text box, and 4 numbered math problems (FIG. 2B). The back face of this card also has 4 numbered answers that correspond to the math problems, written upside down in a text box. A series of 10 or 20 math problem cards is made to be sold in a pack or box.

### EXAMPLE 3

### Addition Card With Answers Placed Sideways

The card shown in FIGS. 3A-B is made by printing the elements shown in the figures on white, card stock (Hammermill wt. 110 lbs.) on a high quality laser printer, and cut to 2½″ (width) by 3½″ (length). “Addition” is the header that is placed at the bottom of the front face, along with a famous baseball player's image, and the player's name, position and team at the top. (FIG. 3A) The back face of the math problem card is printed with card number (i.e., 3), the actual player's statistics printed outlined in a text box, and 4 numbered math problems (FIG. 3B). The back face of this card also has 4 numbered answers that correspond to the math problems, written sideways in a text box. A series of 10 or 20 math problem cards is made to be sold in a pack or box.

### EXAMPLE 4

### Types of Math Problems

The following are examples of types of math problems along with statistics, formulas and/or instructions that appear on mathematical sports learning cards.

A. Type: Addition of Whole Numbers

Header: Addition of Whole Numbers

Instruction: Times On Base is the total of hits, walks, and hit by pitches:

Formula: Times On Base=hits+walks+hit by pitches

Question: A player had 163 hits, 39 walks and was hit by a pitch three times. How many times was he on base this season?

Answer: 163+39+39=205

The player was on base 205 times this season.

(statistics obtained from www.baseball-reference.com)

B: Type: Comparing and Addition of Decimal Numbers

Header: Comparing and Addition of decimals Numbers

Instruction: To add decimals: line up the decimal points first, then add.

To compare decimals:
First line up the decimal points. This will line up the digits in the tenths place, hundredths place, thousandths place, etc.
If there are any empty spots, use zeros as place holders in the empty spots.
Begin comparing on the left side.
   If the digits are the same, move on to the right to the next place.
If the digits are different, the number with the higher digit is larger.

Formula: OPS=on base percentage+slugging percentage

OPS stands for On base Plus Slugging.

Question: In 1994, a player #1 had an on base percentage of 0.419 and slugging percentage of 0.562. In the same year, player #2 had an on base percentage of 0.380 and slugging percentage of 0.603. Which player had the higher OPS?

Answer:

Player #1's OPS=0.981; Player #2's OPS=0.983.

So Player #2 had a higher OPS.

(statistics from www.baseball-reference.com)

C: Type: Multi-step Problem Solving with Addition and Division with Decimal Quotient

Header: Fielding percentage

Formula: Fielding percentage is calculated by:

$$\frac{assists + putouts}{assists + putouts + errors}$$

Instructions: It is expressed as a decimal rounded to the nearest thousandth.

To the round decimals to the nearest thousandth,

first circle the place to which you are rounding (the thousandths place)

then underline the digit to the right of that

the underlined digit tells the circled digit what to do

if the underlined digit is 5 or more, round the circled digit up one

if the underlined digit is less than 5, leave the circled digit the same

Question: At third base in 2004, a player had 93 putouts, 325 assists, and 10 errors. What was his fielding percentage?

Answer:

$$\frac{325 + 93}{325 + 93 + 10} = \frac{418}{428} = .9766355 … Rounded to about .977$$

The player's fielding percentage in 2004 was 0.977.

(statistics from www.basebal1-reference.com)

D: Type: Division of Whole Numbers with Decimal Quotient

Header: Division of whole numbers

Formula:

An On Base Percentage is the total number of times on base divided by the total number of plate appearances:

$$On Base Percentage = \frac{times on base}{plate appearances}$$

It is expressed as a decimal rounded to the nearest thousandth.

Instructions:

To the round decimals to the nearest thousandth,

first circle the place to which you are rounding (the thousandths place)

then underline the digit to the right of that

the underlined digit tells the circled digit what to do

if the underlined digit is 5 or more, round the circled digit up one

if the underlined digit is less than 5, leave the circled digit the same

Question: In 2004, a player reached base 179 times in 539 plate appearances. What is his On Base Percentage?

Answer:

$$\frac{179}{539} = .3320964 … rounded to about .332$$

The player's On Base Percentage is 0.332.

(statistics from www.baseball-reference.com)

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A mathematical sports learning card that comprises:
a first face having a pictorial representation of one or more sports players, and a header to identify a type of one or more math problems;
a second face having sports statistics for use in the math problem, and one or more math problems utilizing the sports statistics; and
an answer to the math problem, wherein the answer is placed either on a separate answer card, or on the second face in lettering that is set apart from the question.

2. The mathematical sports learning card of claim 1, wherein the pictorial representation of the one or more sports players includes baseball players, football players, soccer players, basketball players, hockey players, or Olympic players.

3. The mathematical sports learning card of claim 1, the header to identify the type of math problem includes a header for addition, subtraction, multiplication, division, averages, or combinations thereof.

4. The mathematical sports learning card of claim 1, wherein the card has a length between about 1½″ to about 8½″, and a width between about 1½″ to about 6½″.

5. The mathematical sports learning card of claim 1, the sports statistics on the second face includes statistics from games played by the player or by the player's team.

6. The mathematical sports learning card of claim 1, the math problems on the second include addition problems, subtraction problems, multiplication problems, division problems, problems to calculate averages, or combinations thereof.

7. The mathematical sports learning card of claim 1, wherein the first face further includes the player's name, position, team, or combination thereof.

8. The mathematical sports learning card of claim 1, wherein the second face further includes a formula used to solve the math problems.

9. The mathematical sports learning card of claim 1, wherein the answer to the math problem is included on the second face of the card in lettering that is upside down or sideways.

10. A mathematical sports learning answer card that correlates to the card of claim 1, that comprises:
a first face having a pictorial representation the one or more sports players, and said header that correlates to the header of the card of claim 1; and
a second face having the answer to the one or more math problems of the card of claim 1.

11. A mathematical sports learning card system that comprises:
a plurality of math problem cards that comprise:
a first face having a pictorial representation of one or more sports players, and a header to identify the type of one or more math problems; and
a second face having sports statistics for use in one or more math problems, and one or more math problems that require use of the sports statistics to solve the math problem; and
a plurality of corresponding answer cards that comprise:
a first face having a pictorial representation the one or more sports players, and said header that corresponds to said math problem card; and
a second face having answer to the one or more math problems.

12. A mathematical sports learning card system that comprises a plurality of the mathematical learning sports card of claim 1.

13. A method of using a mathematical sports learning card that comprises a first face having a pictorial representation of one or more sports players, and a header to identify the type of math problem; a second face having sports statistics for use in the math problem, and one or more math problems that require use of the sports statistics to solve the math problem; and answer to the math problem, wherein an answer is placed either on a separate answer card, or on the second face in lettering that is set apart from the question; the method comprises:
introducing the math problem to an individual;
determining a possible answer by the individual; and
comparing the possible answer with the answer on the separate answer card or on the second face of the card.

14. The method of claim 13, wherein the method is performed with two or more individuals.

15. A mathematical sports learning card game that comprises;
a plurality of math problem cards that comprise:
a first face having a pictorial representation of one or more sports players, and a header to identify the type of math problem; and
a second face having sports statistics for use in the math problem, and one or more math problems utilizing the sports statistics; and
a plurality of answers that correspond to the math problem, wherein the answer is placed either on a separate answer card, or on the second face in lettering that is set apart from the question.

16. The mathematical sports learning card game of claim 15, wherein the plurality of answer cards comprise:
a first face having a pictorial representation the one or more sports players, and said header that corresponds to said math problem card; and
a second face having answer to the one or more math problems.

17. The mathematical sports learning card game of claim 16, further comprising a spinner, one or more dice, a game board, or combination thereof.

18. A method of making a mathematical sports learning card that comprises:
placing a pictorial representation of one or more sports players and a header to identify the type of math problem on a first face of the card;
placing sports statistics for use in the math problem, and one or more math problems that require use of the sports statistics to solve the math problem on the second face of the card; and
placing the answer to the math problem either on a separate answer card, or on the second face in lettering that is set apart from the question.
